(19) United States
(12) Patent Application Publication
(10) Pub. No.: US 2017/0286417 A1
(43) Pub. Date: Oct. 5, 2017

(54) DEDUPLICATING DATA ACROSS SUBTENANTS

(71) Applicant: HEWLETT PACKARD ENTERPRISE DEVELOPMENT LP, Houston, TX (US)

(72) Inventors: Mark Lillibridge, Palo Alto, CA (US); Doug Voigt, Boise, ID (US); Vitaly Oratovsky, Andover, MA (US); Scott Grumm, Boulder, CO (US)

(73) Assignee: Hewlett Packard Enterprise Development LP, Houston, TX (US)

(21) Appl. No.: 15/507,232

(22) PCT Filed: Nov. 4, 2014
(86) PCT No.: PCT/US2014/063823

§ 371 Date: Feb. 27, 2017

(51) Int. Cl. G06F 17/30

(52) U.S. Cl. CPC G06F 17/3015; G06F 17/30489; G06F 17/30; G06F 11/1453

(57) ABSTRACT

A technique includes deduplicating data across subtenants of a tenant of a cloud service. The technique includes applying a rule to apportion a fee reduction due to the deduplication among the subtenants.

### BACKGROUND

A typical cloud service provides a pool of hosted computing resources and/or storage resources for its customers. The cloud service may offer several advantages for a given customer, as compared to the customer hosting and managing the resources, such as advantages pertaining to reducing capital costs, achieving economies of scale, creating flexibility to expand computing infrastructure and/or services as needed, increasing accessibility to resources, and so forth.

### BRIEF DESCRIPTION OF THE DRAWINGS

FIG. 1 is a schematic diagram of a cloud computing system according to an example implementation.

FIGS. 2 is a flow diagram depicting a technique to deduplicate data according to an example implementation.

FIGS. 3A and 3B are flow diagrams depicting a technique to apportion a fee reduction among subtenants according to an example implementation.

FIG. 4 is a flow diagram depicting a technique to account for cloud service fees according to an example implementation.

FIG. 5 is a flow diagram depicting a technique to deduplicate public file-based data among tenants according to an example implementation.

FIG. 6 is a schematic diagram of a physical machine according to an example implementation.

### DETAILED DESCRIPTION

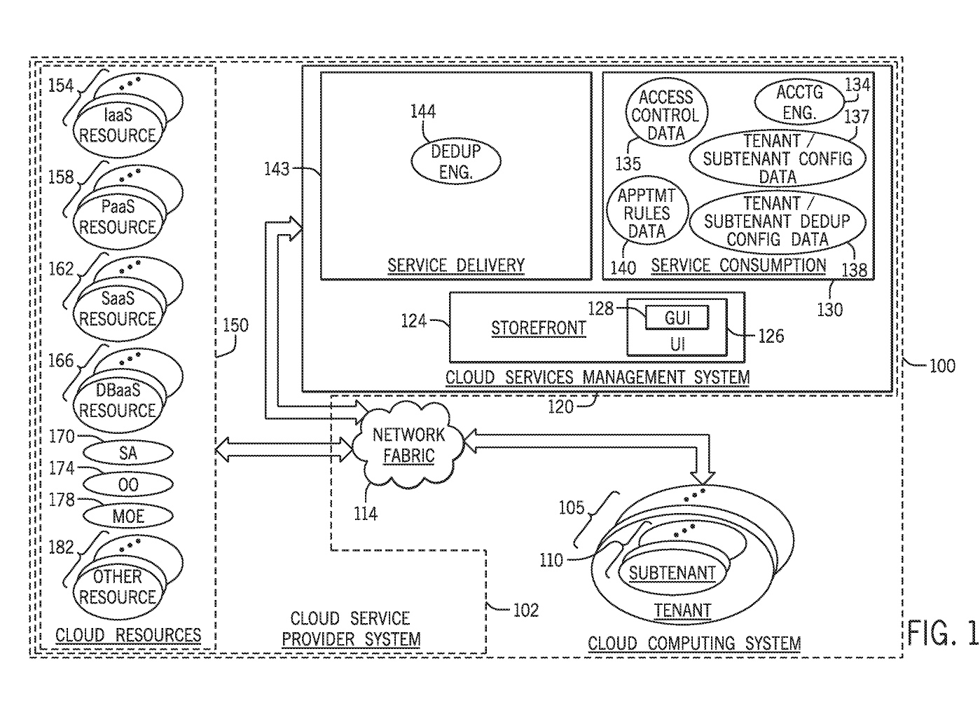

Referring to FIG. 1, in accordance with systems and techniques that are disclosed herein, a cloud computing system 100 includes a cloud service provider system 102, which provides cloud services to computing systems (desktop computers, portable computers, tablets, thin clients, smartphones, and so forth) of subscribing tenants 105. More specifically, the cloud service provider system 102 includes a hosted pool of computing and storage resources 150 and a cloud services management system 120. The cloud services management system 120 manages access to the cloud resources 150 by the tenants 105, as well as controls the provisioning and allocation of the resources 150 for the tenants 105.

As examples, the cloud resources 150 may include such resources as Infrastructure as a Service (IaaS) resources 154 (resources that provide hosted equipment, such as computing components, storage components and network components as a service); Platform as a Service (PaaS) resources 158 (resources that provide hosted computing platforms, such as platforms having an operating system, hardware, storage, and so forth); Software as a Service (SaaS) resources 162 (resources that provide hosted applications as a service); DataBase as a Service (DBaaS) resources 166 (resources that provide hosted database as a service); and so forth.

The cloud resources 150 may include, in accordance with example implementations, resources that provide services that are useful for the cloud services, such as resources 170, 174 and 178 pertaining to Server Automation (SA), Database Middleware Automation (DMA), Matrix Operating Environment (MOE), or Operations Orchestration (OO), respectively, as well as other infrastructure provisioning system(s) or IaaS provisioning system(s). The cloud resources 150 may include other cloud resources 182, in accordance with further example implementations.

As depicted in FIG. 1, the cloud resources 150, the tenants 105 and the cloud services management system 120 may be intercoupled by network fabric 114. In general, the network fabric 114 represents network cabling, switches, routers, gateways and the like and which may include fabric formed from one or more of the following: local area network (LAN) fabric, wide area network (WAN) fabric and Internet fabric. The cloud services management system 120 may reside on one or multiple Internet servers; may reside on one or multiple servers within a private LAN; may reside on one or multiple servers of a WAN; may reside on one or multiple blade servers of a rack or datacenter; or may be a SaaS (Software as a Service), as just a few examples.

As examples, the cloud service provider system 102 may be a publically accessible cloud computing system (a system for which the cloud service is accessed using the Internet, for example) that is generally publically open to all potential users; a limited access private cloud computing system, where cloud service is provided over a private network; a cloud computing system that provides a managed cloud service (e.g., a virtual private network accessible cloud service); or a hybrid cloud computing system, which may be a combination of two or more of the foregoing cloud computing systems.

In general, an authorized human administrator for a given tenant 105 may select, order and manage cloud services for the tenant 105 by communicating with the cloud services management system 120. In this manner, using a computing system, the administrator may communicate with a store front 124 of the cloud services management system 120 and in particular interact with a user interface 126 (such as a graphical user interface (GUI) 128) of the store front 124 for purposes of selecting, ordering and managing cloud services for the tenant 105.

The cloud services management system 120, in general, may strive to provide isolation among the tenants 105. In accordance with example implementations, as part of providing this isolation among tenants 105, the cloud services management system 120 undertakes measures to ensure that a given tenant 105 may not access data used by another tenant 105 or indirectly learn of data used by another tenant 105.

For example, the cloud services management system 120 may protect tenant privacy when providing a data deduplication service. In general, the data deduplication service reduces the amount of data stored in the system 102. In data deduplication, repeating, or redundant, units of data (called “chunks”) are identified, and the redundant chunks are replaced with references that point to corresponding stored, single instances of the chunks. A given tenant 105 may financially benefit from the data deduplication service, in that the reduced data storage may result in a fee reduction from the cloud service provider.

For purposes of preserving data isolation among the tenants 105, the cloud service provider may place boundaries on the data deduplication so that, in general, the deduplication service is performed across individual tenants 105 but not across multiple tenants 105 (i.e., the data deduplication for a given tenant 105 considers the data for that individual tenant 105 and not data associated with any other tenant 105). In this manner, if deduplication were to otherwise occur across tenants 105, a given tenant 105 may indirectly learn which data the tenant 105 shares in common with other tenants 105 based on the given tenant's deduplicated data.

For purposes of providing the data deduplication service, the cloud services management system 120 includes a deduplication engine 144 (part of its service delivery component 143). In accordance with example implementations, as part of the deduplication for a given tenant 105, the deduplication engine 144 identifies repeating, or redundant, chunks of data for the tenant 105 and replaces redundant chunks with reference(s) that point to stored chunks. The deduplication engine 144 may control or primarily consist of components running on the cloud resources being leased to the tenant 105, in accordance with example implementations.

As a more specific example, in accordance with example implementations, the tenants 105 may be affiliated with different business enterprises. One way for a business enterprise to take advantage of a data deduplication service that is provided by a cloud service provider while still preserving the privacy of the enterprise is for the enterprise to combine all of its “groups” (its business units, for example) into a single tenant designation, i.e., use a single tenant account for all groups. Thus, the entire business enterprise is designated as being a single tenant 105 for purposes of receiving cloud services from the cloud service provider system 102. Although the business enterprise may benefit from data deduplication from such consolidation, as reduced data storage may result in reduced cloud service fees and/or fee reductions from the cloud service provider, combining groups (business units, for example) of a given tenant 105 into the single tenant designation results in no billing separation or cost control among the tenant's groups.

A given business enterprise may alternatively designate its groups as separate tenants 105 and thus, set up separate tenant accounts for the groups with the cloud service provider. Although this arrangement may benefit the business enterprise from the standpoint of billing separation and cost control, the data shared in common among the groups is not consolidated, thereby reducing the amount of data deduplication (and reducing fee reductions due to data deduplication).

In accordance with systems and techniques that are disclosed herein, a given tenant 105 may classify at least some of its groups as being corresponding subtenants 110 of the tenant 105. In this manner, the tenant 105 may have an account, and the tenant 105 may set up separate subaccounts for its subtenants 110. The deduplication engine 144 is constructed to perform data deduplication across the subtenants 110 of a given tenant 105, as isolation of data is not a concern for subtenants 110 of the same tenant 105. In words, the deduplication engine 144, when performing deduplication for the tenant 105, considers the data for all of the subtenants 110. The ability to deduplicate data across the subtenants 110 provides a corresponding cost savings, or fee reduction, for the tenant 105; and this fee reduction may be apportioned among cloud service bills for the subtenants 110 (as further described herein), thereby creating billing separation and cost control among the tenant's groups.

For purposes of generating tenant and subtenant invoices, or bills, the cloud services management system 120 includes an accounting engine 134, which may be a service consumption component 130 of the cloud services management system 120, as depicted in FIG. 1. For a given tenant 105, the accounting engine 134 is constructed to determine a fee reduction due to data deduplication, regardless of the number of subtenants 110 of the tenant 105.

In this manner, the accounting engine 134 credits savings due to data deduplication to the tenant 105 for the purpose of the tenant's bill. The cloud service provider may provide some form of volume discount or “elite status,” due to the amount of resources the tenant 105 is consuming, and the accounting engine 134 is constructed to apply this discount or fee reduction at the tenant level because the fee reduction is based on the amount of resources consumed by the tenant 105. To allow greater cost control for the tenant 105, the accounting engine 134 is further constructed to generate bills for the subtenants 110 of the tenant 105; select and apply a rule to apportion the fee reduction due to data deduplication among the subtenants 110; and credit the apportioned fee reductions to the subtenant bills, as further disclosed herein.

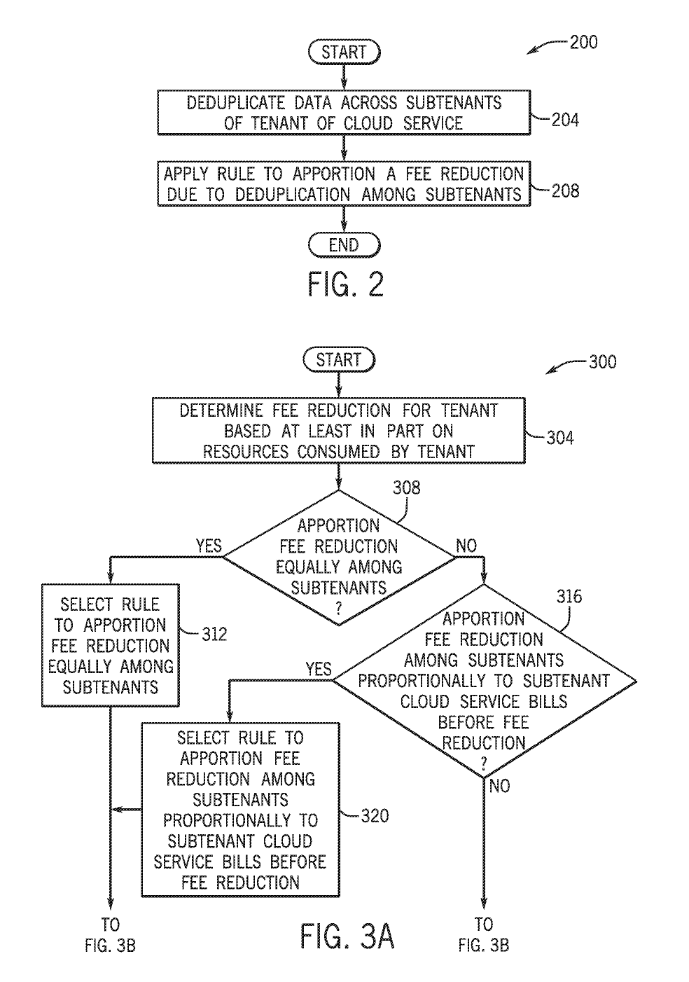

Thus, referring to FIG. 2 in conjunction with FIG. 1, in accordance with example implementations, a technique 200 includes deduplicating data across subtenants of a tenant of a cloud service, pursuant to block 204. The technique 200 includes applying (block 208) a rule to apportion a fee reduction due to the deduplication among the subtenants.

From the viewpoint of the cloud service provider, providing subtenant bills is a convenience for the customer, as the cloud service provider expects to be paid the overall invoice amount for a given tenant 105, either by the tenant 105 on behalf of all of the subtenants 105 or in aggregate as a sum of payments by the subtenants 110. In other words, the sum of the subtenant bills should equal the tenant bill.

In accordance with example implementations, the accounting engine 134 charges the fees for the resource usage entirely within a given subtenant 110 (including non-duplicate storage) to that subtenant 110. Moreover, the accounting engine 134 may apportion charges for communication between two subtenants 110 equally (i.e., fifty percent to each subtenant 110). The accounting engine 134 may, per the customer's request, apply a different percentage (for particular subtenant pairs), including different percentages for the different directions. The accounting engine 134 may further distribute volume discounts proportionally, in accordance with example implementations.

Referring to FIG. 1, among its other features, the cloud services management system 120 may store access control data 135, which, may, for example, contain the login information and passwords for the human administrators of the tenants 105 and subtenants 110. In accordance with example implementations, a given tenant 105 may authorize one or multiple human administrators for the tenant 105 for purposes of subscribing to, configuring and managing the cloud services for each of the tenant 105; and the tenant 105 may authorize one or multiple human administrators for purposes of subscribing to, configuring and managing the cloud services for the subtenants 110 of the tenant 105.

The service consumption component 130 may further include tenant/subtenant configuration data 137, which describes the cloud services for the tenants 105 and subtenants 110, rules data 140 for purposes of specifying apportionment rules for apportioning fees and fee reductions among subtenants 110 of each tenant 105; and tenant/subtenant deduplication configuration data 138, which specifies which data is to be deduplicated for a given tenant and/or subtenant 110. In addition to providing data deduplication services, the service delivery component 143 may provide other cloud for the customers of the cloud service.

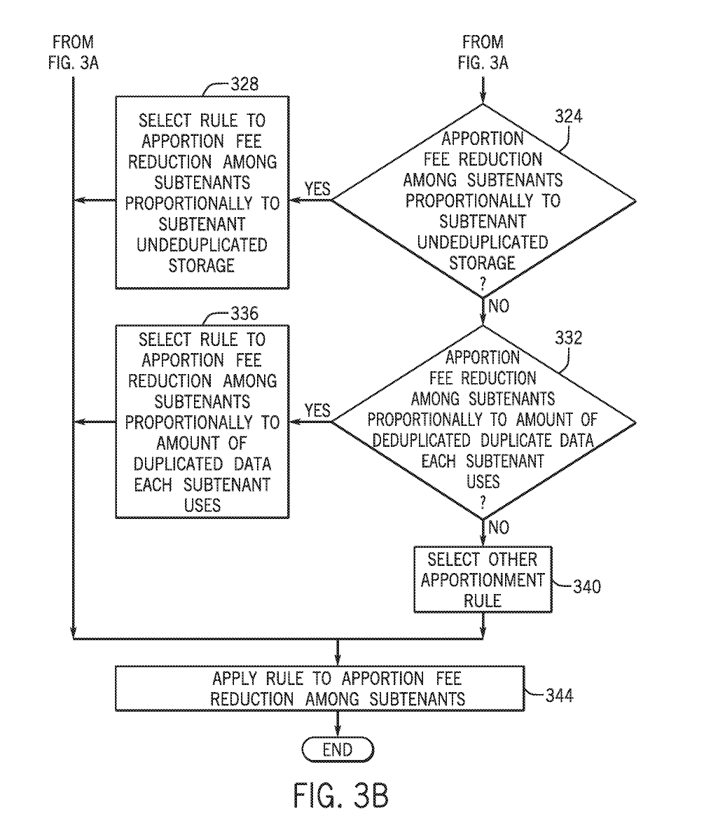

FIGS. 3A and 3B depict a technique 300 that the accounting engine 134 may use to apportion a fee reduction among subtenants, in accordance with example implementations. Referring to FIG. 3A in conjunction with FIG. 1, pursuant to the technique 300, the accounting engine 134 determines (block 304) a fee reduction for a tenant based at least in part on resources consumed by the tenant. In this manner, the fee reduction may be at least partially based on a reduction in storage space due to data deduplication among the tenant's subtenants.

Next, the accounting engine 134 makes decisions for purposes of selecting the appropriate apportionment rule, as selected by the tenant 105. Although FIGS. 3A and 3B depict these rules in a particular sequence, no particular order in selecting the rule is implied. Moreover, the accounting engine 134 may select the rules in many other ways, such as selecting the rules in another sequence, selecting the rules in a parallel manner, selecting the rules using a table lookup, and so forth. In general, the selection of the rule may be based on apportionment rules data 140 (see FIG. 1) that is configured by the customer.

For the implementation that is depicted in FIG. 3A, the accounting engine 134 determines (decision block 308) whether the fee reduction should be apportioned equally among the subtenants 110, and if so, the accounting engine 134 selects (block 312) a rule to apportion the fee reduction equally among the subtenants. Otherwise, the accounting engine 134 determines (decision block 316) whether the fee reduction should be apportioned among the subtenants 110 proportionally to the subtenant cloud service bills before the fee reduction is applied, and if so, the accounting engine 134 selects (block 320) a rule to apportion the fee reduction among the subtenants proportionally to the subtenant bills before the fee reduction.

Referring to FIG. 3B, in conjunction with FIG. 1, otherwise, the accounting engine 134 determines (decision block 324) whether to apportion the fee reduction among the subtenants 110 proportionally to the amount of storage (before deduplication) each subtenant 110 uses, and if so, the accounting engine 134 selects a rule to apportion the fee reduction among the subtenants proportionally to the subtenant undeduplicated cloud storage, pursuant to block 328. If the accounting engine 134 determines (decision block 324) that the fee reduction is not to be applied based on cloud storage bills, the accounting engine 134 determines (decision block 332) whether to apportion the fee reduction among the subtenants proportionally to the amount of deduplicated duplicate data (that is, the amount of data belonging to that subtenant that was eliminated through deduplication) each subtenant 110 uses, and if so, the accounting engine 134 selects (block 336) a rule to apportion the fee reduction among the subtenants proportionally to the amount of deduplicated duplicate data that each subtenant uses. Otherwise, the accounting engine 134 selects (block 340) another rule to apportion the fee reduction among the subtenants 110. Using the selected rule, the accounting engine 134 applies (block 340) the rule to apportion the tenant's fee reduction among the subtenants.

Referring to FIG. 1, in accordance with example implementations, the accounting engine 134 may provide a further refinement in that the accounting engine 134 provides for each subtenant 110 an invoice, or bill, for the cost of cloud services if the subtenant 110 was hypothetically considered to be a separate tenant 105. That is, the subtenant 110 receives a bill based on the premise that the subtenant 110 could not deduplicate against the other subtenant(s) 110 of that tenant 105, and correspondingly, the volume discount/elite status is proportional to the resources that the subtenant 110 consumes. This alternative bill may be beneficial for the tenant for the case in which subtenant resources are serving a customer of the tenant 105. In this manner, by the tenant 105 offering its customer the lower of the two bills, the tenant 105 may guarantee to its customer that the customer is not being penalized by being part of the subtenant group while still offering the customer a share of tenant's volume/deduplication savings.

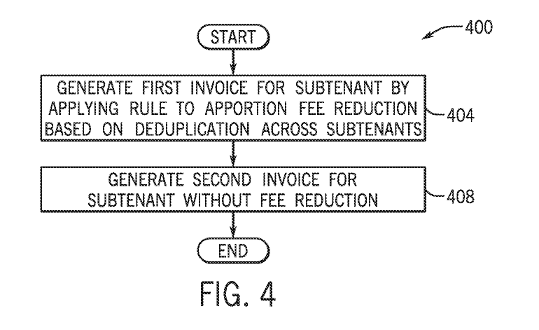

Thus, referring to FIG. 4 in conjunction with FIG. 1, in accordance with example implementations, the accounting engine 134 performs a technique 400, which includes generating (block 404) a first invoice for a subtenant by applying a rule to apportion a fee reduction due to subtenant deduplication (that is, deduplication across subtenants) and generating (block 408) a second invoice for the subtenant without the fee reduction due to the subtenant deduplication. Fee reductions due to deduplication within a subtenant may be included in both invoices.

As a further example implementation, the cloud service provider may allow deduplication across tenants for the limited case in which the deduplicated data is associated with “public” files. For example, in accordance with some implementations, the cloud service provider may provide a data deduplication service for publically available Windows® operating system files, publically available application files, and so forth. A given tenant 105 may, via a selected option of its cloud service subscription, configure the deduplication engine 144 to include the tenant 105 in a public data file-based data deduplication across multiple tenants 105. Although such data deduplication across tenants 105 may reveal that public data is shared among the tenants (very unsurprising and thus not leaking of information), isolation for private data is still preserved among the tenants 105.

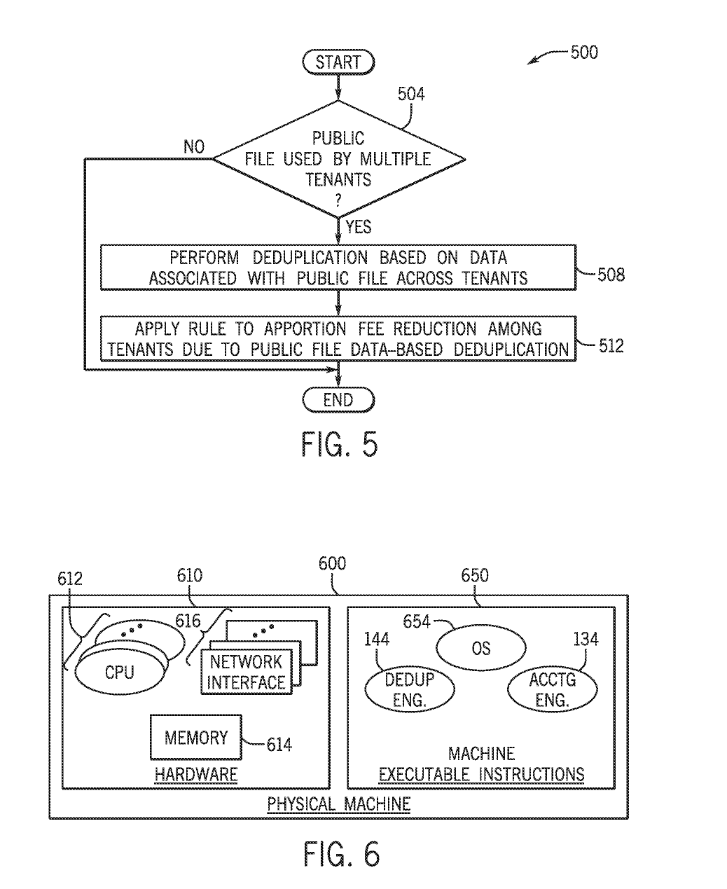

Thus, referring to FIG. 5 in conjunction with FIG. 1, in accordance with example implementations, the deduplication engine 144 performs a technique 500 that includes determining (decision block 504) whether a public file is used by multiple tenants, and if so, the deduplication engine 144 performs (block 508) deduplication across the tenants for the public file data. In accordance with example implementations, the cloud service provider may pass all or some of the resulting cost savings to the tenants. In this manner, as depicted in FIG. 5, the accounting engine 134 may apply (block 512) a rule to apportion a fee reduction among the tenants due to the public file data-based deduplication.

Referring to FIG. 6 in conjunction with FIG. 1, in accordance with example implementations, the cloud services management system 120 of FIG. 1 includes one or multiple physical machines, such as example physical machine 600. The physical machine 600 is an actual machine that is made up of actual hardware 610 and actual machine executable instructions 650, or “software.” Although the physical machine 600 is depicted in FIG. 6 as being contained within a corresponding box, a given physical machine 610 may be a distributed machine, which has multiple nodes that provide a distributed and parallel processing system in accordance with example implementations. In accordance with example implementations, the physical machine 600 may be located within one cabinet (or rack); or alternatively, the physical machine 600 may be located in multiple cabinets (or racks).

The physical machine 600 may include such hardware 610 as one or more central processing units 612 (CPUs) and a memory 614 that stores machine executable instructions, application data, configuration data and so forth. The memory 614 may include volatile and non-volatile storage devices, depending on the particular implementation. In general, the memory 614 is a non-transitory memory, which may include such storage devices as semiconductor storage devices, memristors, phase change memory devices, magnetic storage devices, optical storage devices, and so forth.

The physical machine 600 may include various other hardware components, such as one or multiple network interfaces 616 and one or more of the following: mass storage drives; a display; input devices, such as a mouse and a keyboard; removable media devices; and so forth.

The machine executable instructions 650, when executed by the CPU(s) 612, cause the CPU(s) 612 to form one or more components of the cloud service management system 120, such as the deduplication engine 144 and accounting engine 134. Moreover, the machine executable instructions 650 may, when executed by the CPU(s) 612, form other software components, such as an operating system 654, device drivers, applications, and so forth.

Referring to FIG. 1, as an example, cloud service management system 120 may be an application server farm, a cloud server farm, a storage server farm (or storage area network) a web server farm, a switch, a router farm, and so forth. Although a single physical machine 600 is depicted in FIG. 6, it is understood that the cloud management system 120 may contain a single physical machine, two physical machines or more than two physical machines, depending on the particular implementations. Moreover, the cloud management system 120 may have an architecture over than the one depicted in FIG. 6, in accordance with further example implementations.

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. A method comprising:
deduplicating data across subtenants of a tenant of a cloud service; and
applying a rule to apportion a fee reduction due to the deduplication among the subtenants.

2. The method of claim 1, wherein applying the rule to apportion the fee reduction comprises one of the following:
apportioning the fee reduction equally among the subtenants;
apportioning the fee reduction proportionally to cloud service bills associated with the subtenants before the fee reduction;
apportioning the fee reduction proportionally to cloud storage sizes used by the subtenants before the deduplication; and
apportioning the fee reduction proportionally to sizes of deduplicated duplicate data used by the subtenants.

3. The method of claim 1, further comprising applying a rule to apportion a fee among the subtenants due to resources used by the subtenants.

4. The method of claim 1, wherein the tenant is one of a plurality of tenants of the cloud service, the method further comprising:
deduplicating data associated with at least one public file across at least two tenants of the plurality of tenants; and
applying a rule to apportion a fee reduction due to the deduplication among the at least two tenants.

5. The method of claim 1, further comprising:
applying a rule to apportion a fee reduction due to a volume discount for the tenant among the subtenants.

6. The method of claim 5, further comprising:
generating a first invoice for a subtenant of the plurality of tenants based at least in part on applying the fee reduction due to the deduplication and applying the fee reduction due to the volume discount for the tenant; and
generating a second invoice for the subtenant without applying the fee reduction due to the deduplication and the fee reduction due to the volume discount for the tenant.

7. An article comprising a non-transitory computer readable storage medium to store instructions that when executed by a processor-based system cause the processor-based system to:
deduplicate data across subtenants of a tenant of a cloud service; and
apply a rule to apportion a fee reduction due to the deduplication among the subtenants.

8. The article of claim 7, the storage medium to store instructions that when executed by the processor-based system cause the processor-based system to apply a rule to apportion a fee among the subtenants due to resources used by the subtenants.

9. The article of claim 7, wherein the tenant is one of a plurality of tenants of the cloud service and the storage medium to store instructions that when executed by the processor-based system cause the processor-based system to:
deduplicate data associated with at least one public file across at least two tenants of the plurality of tenants; and
apply a rule to apportion a fee reduction due to the deduplication among the at least two tenants.

10. The article of claim 7, the storage medium to store instructions that when executed by the processor-based system cause the processor-based system to apply a rule to apportion a fee reduction due to a volume discount for the tenant among the subtenants.

11. The article of claim 10, the storage medium to store instructions that when executed by the processor-based system cause the processor-based system to:
generate a first invoice for a subtenant of the plurality of tenants based at least in part on applying the fee reduction due to the deduplication and applying the fee reduction due to the volume discount for the tenant; and
generate a second invoice for the subtenant without applying the fee reduction due to the deduplication and the fee reduction due to the volume discount for the tenant.

12. An apparatus comprising:
a deduplication engine comprising a processor to deduplicate data across subtenants of a tenant of a cloud service; and
an accounting engine comprising a processor to apply a rule to apportion a fee reduction due to the deduplication among the subtenants.

13. The apparatus of claim 12, wherein the accounting engine applies the rule to apportion the fee reduction by:
apportioning the fee reduction equally among the subtenants;
apportioning the fee reduction proportionally to cloud service bills associated with the subtenants before the fee reduction;
apportioning the fee reduction proportionally to cloud storage sizes used by the subtenants before the deduplication; and
apportioning the fee reduction proportionally to sizes of deduplicated duplicate data used by the subtenants.

14. The apparatus of claim 13, wherein the deduplication engine deduplicates data across the tenants associated with a public file.

15. The apparatus of claim 13, wherein the accounting engine applies a rule to apportion a fee reduction due to a volume discount for the tenant among the subtenants.
